(19) United States
(12) Patent Application Publication
(10) Pub. No.: US 2012/0029981 A1
(43) Pub. Date: Feb. 2, 2012

(54) Method and System of Distributing Charitable Contributions

(76) Inventor: Brad Barton, Huntington Beach, CA (US)

(21) Appl. No.: 13/192,326

(22) Filed: Jul. 27, 2011

Related U.S. Application Data
(60) Provisional application No. 61/368,215, filed on Jul. 27, 2010.

(51) Int. Cl. G06Q 30/00; G06Q 40/00

(52) U.S. Cl. 705/14.1; 705/39; 705/14.66

(57) ABSTRACT

A method and system of distributing charitable contributions where a sponsoring entity donates money to a charitable organization of a user's choosing via a nonprofit administrative entity. In return, the sponsoring entity receives contact information of the user, such as user's email, text, IM, for advertisement purposes. Sponsoring entities and users are matched based on the sponsoring entity's profile and user's profile, which may include the contents of the user's electronic communications.

### CROSS-REFERENCE TO RELATED APPLICATION

This patent application claims the benefit of U.S. Provisional Patent Application No. 61/368,215, entitled “METHOD AND SYSTEM OF DISTRIBUTING CHARITABLE CONTRIBUTIONS,” filed Jul. 27, 2010, which application is incorporated in its entirety here by this reference.

### TECHNICAL FIELD

This invention relates to methods and systems to encourage, obtain, and distribute charitable contributions.

### BACKGROUND ART

There is a massive gap between what charities need to operate and what they actually have available. For qualified causes, it is very sad that the necessary funding is not there. One example is THE SMILE TRAIN® medical services, where doctors donate their time to treat cleft lips and palates. The doctors provide a short procedure that could change a child's life forever. So it is unfortunate when there are not enough funds to cover the operating expenses. A number of charitable organizations, local to global, have similar under-funding.

The question of course is why, given the worthy causes and the number of people needing the services of those causes, are the causes under-funded. One answer is that it does not have an impact on our “everyday life.” Another possibility is lack of awareness of the causes and their goals. Given the amount of money that is spent, available money does not seem to be a limiting factor.

One solution that could impact people's everyday life is e-mail, text messaging, and instant messaging since those communication methods are ubiquitous. This is the basis for the invention disclosed here.

### BRIEF DESCRIPTION OF DRAWINGS

FIG. 1 is a flow chart showing the overall process for an embodiment of a method and system of distributing charitable contributions.

FIG. 2 is a flow chart showing an embodiment of a method and system of distributing charitable contributions from the perspective of a sponsoring entity.

FIG. 3 is a flow chart showing an embodiment of a method and system of distributing charitable contributions from the perspective of a user.

FIG. 4 is a flow chart showing an embodiment of the method and system of distributing charitable contributions from the perspective of a benefitting charitable cause.

### BEST MODE FOR CARRYING OUT THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

Disclosed is a method of distributing charitable contributions from a sponsoring entity to a charitable cause or organization selected by a user via a nonprofit administrative entity. The sponsoring entity, the charitable organization, and the user each register with the nonprofit administrative entity. The sponsoring entity allocates money to the nonprofit administrative entity to donate to at least one of the charitable organizations. How the money is actually distributed or allocated to the charitable organizations is determined by the user.

The role of the nonprofit administrative entity may include converting the donated money to points, or credits, compiling a database of users and user profiles, compiling a database of sponsors and sponsor profiles, allocating credits to users, compiling demographic data of the users, and handling the banking and payment transactions. Through the registration process the administrative entity establishes or maintains a database of the sponsoring entities, charitable organizations, and users. During the registration process, the registrants will provide standard identification and contact information. The charitable organization must further provide sufficient information to establish the legitimacy of the charitable organization to qualify to participate in this program as determined by the administrative entity or some other objective or legal standard.

The user's role is to identify the charitable organizations available to receive a donation from a sponsor. During or after the registration process, the user establishes a user profile and a list designating charitable organizations the user would like to see receive a donation. The user can select a charitable organization from a list of qualified charitable organizations already registered with the administrative entity. The user may also identify, designate, or recommend a new charitable organization not yet registered with the administrative entity. However, before receiving any donations, a new charitable organization must register with the administrative entity and qualify as a proper charitable organization.

The user's profile may contain information about the user, such as user's identification, contact information, characteristics, demographics, interests, preferences, keywords in electronic communications, and/or any other information that allows a sponsor to conduct a query for potential customers that the sponsor may want to target for advertisement purposes. The user may update or change the user's profile at any time.

The sponsoring entity or donating entity, registers with an administrative entity and donates money to the administrative entity that will eventually be allocated to a charitable organization or a various charitable organizations as determined by a user. During or after the registration process, the sponsoring entity may establish a sponsor profile. The sponsor's profile may contain information about the sponsor, such as the sponsor's identification, contact information, types of goods and/or services offered, and/or information that helps identify consumers who may be interested in the sponsor's goods and/or services, such as the types of information contained in a user's profile. Information that helps a sponsor identify consumers who may be interested in the sponsor's goods and/or services is referred to as a correlative. The sponsor's profile, correlatives, and any other information can be changed or updated at any time as well.

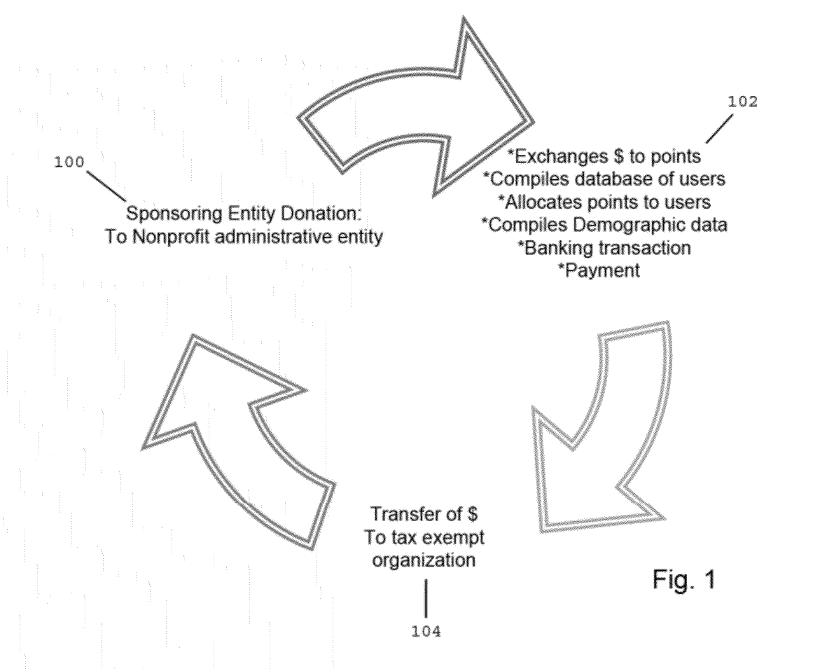

An aspect of the process is shown in FIG. 1. To begin the process, each of the players or entities involved registers with the administrative entity. For example, the user, or allocator, registers and selects one or more charitable causes. The registration process would generally require the user to provide at least the user's contact information, such as mobile phone number, e-mail, or instant messaging information. Each charitable cause, if not previously qualified, is then qualified by verifying it meets predetermined conditions as established by the law and/or the administrative entity. The nonprofit administrative entity notifies the user when the charitable cause is qualified.

From there, the sponsoring entity donates money 100 to the administrative entity. The administrative entity processes all of the information received 102 as it facilitates the proper allocation of the donated money. For example, based on a user's electronic communications behavior, the user or allocator, may begin to receive credits predicated on the user's email messages, which are weighted, and then exchanged periodically (such as monthly) for a dollar total by the administrative entity. Once the information is processed by the administrative entity, a deposit is made (preferably in real cash) to the user's chosen charitable organization or cause 104. These dollars come from one or more sponsoring entities (such as a for-profit corporation), which donate financially as a tax write-off. The user's identification may be sent to the chosen charitable organization with the donation so that the charitable organization knows how the donation came about.

In some embodiments, points or credits, are accrued by content of the user's email, or other electronic communications, using one or more correlatives, such as keywords, catch phrases, and strike points designated by the sponsor. The dollar value could be as little or large as a standard company marketing budget or what it would spend in charitable contributions. The way the credits are totaled is secondary to the fact that now these people, who never would consider a philanthropic cause, are able to help contribute to a charitable cause. So, by way of example, 1500 credits could equal one dollar or one cent, depending on the terms and conditions or other factors.

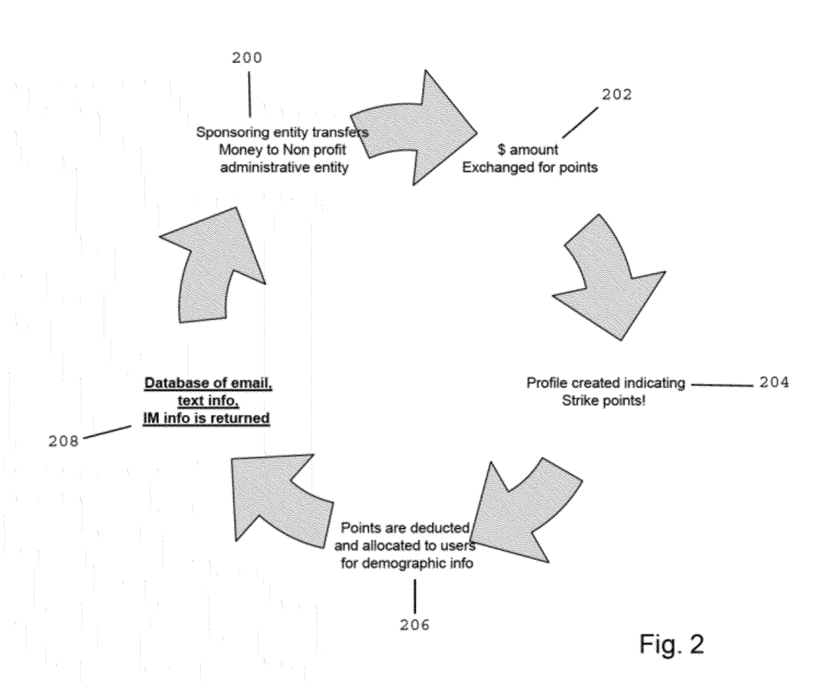

FIG. 2 further elaborates on the process shown in FIG. 1. The sponsoring entity, or donating entity, donates money to the nonprofit administrative entity 200. The administrative entity maintains a sponsor profile indicating correlatives sought or specified by the sponsoring entity. In some embodiments, the nonprofit administrative entity may allocate credits to users 202 based on whether the user's electronic communications, or other information in the user's profile, matches the sponsor's correlatives. As part of creating the user's profile 204, the administrative entity collects demographic information of users or other information of the user that is of interest to the sponsor that may help identify whether the user could be a prospective consumer of the sponsor's goods or services. If the administrative entity establishes a match between a user and a sponsor, then the administrative entity credits the user with the money donated by the sponsor 206, and sends contact information of the matching user 208 to the sponsor so that the sponsor can send a targeted advertisement to that user. For example, the nonprofit administrative entity may provide the user's email, text, IM, and demographic information to the sponsoring entity.

After a designated period of time or event, the user can convert any credits to actual dollar amounts depending on a designated exchange rate. The user can then designate the charitable organization(s) that will receive the money. In some embodiments, the exchange rate may be fixed. In some embodiments, the exchange rate will be determined based on the total amount contributed by a sponsor and the total credits that were distributed by the administrative entity. The administrative entity may have to keep track of which sponsor's credit is being given to a particular user so as to create the proper exchange rate. In some embodiments, the nonprofit administrative entity may also provide a periodic (such as monthly) indication to the user of the user's total credits or credits available for certain charitable organizations.

The benefit to the sponsoring entity is that it can market to a focused, captive customer base, being the users. The sponsoring entity has the ability to write off all or a portion of these expenses, which normally would have been standard marketing expenses. Also, the sponsoring entity is doing something good by funding the charitable cause.

By way of example, a running shoe manufacturer becomes a sponsoring entity and selects one or more correlatives, such as the keyword “running ” When a user sends an email, text message, or instant message that includes the word “running,” the recipient sees the email, text message, or instant message along with a noninvasive message that the recipient can click on to learn more about the services of the nonprofit administrative entity. Preferably, this message is an embedded sentence at the bottom of the user's email signature that includes a hyperlinked message such as “This email sent for a cause.” If the email recipient is interested, the recipient clicks on the hyperlink and is directed to another website, such as the administrative entity's website, or a side bar within the email product. The user is then awarded with credits from the sponsors who indicated “running” as their correlative, and the recipient has the opportunity to sign up with the administrative entity to also be a user.

In some embodiments, if the recipient does not click on the hyperlink, the user's total credits stay the same and the recipient does not become a new user. In some embodiments, the user may receive a credit simply by sending the email containing a correlative.

In a version of the invention, the sponsoring entity could have a specific website within the website of the administrative entity that is related to the services of the administrative entity.

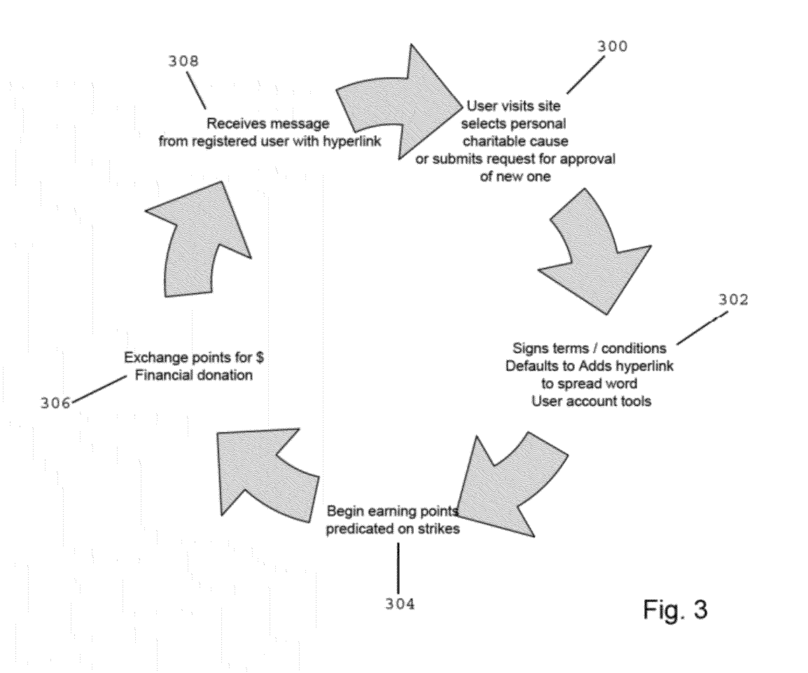

FIG. 3 shows the process from the perspective of the user, or allocator. The user visits the administrative entity's website (and registers if not previously registered) and selects one or more charitable causes 300 from the qualified causes or submits a request for qualification of a new one. The user may also be required to approve the terms and conditions that, among other things, may add a hyperlink to the user's e-mails, text messages, or instant messages 302. The user then will begin to earn points or credits 304, based on the number of strikes or click-throughs of the hyperlink. In some embodiments, just sending the email containing the correlative earns points or credits. The nonprofit administrative entity then exchanges the cumulative credits for money and allocates the money to the one or more charitable causes selected by the user 306. In the meanwhile, the recipient receives the electronic communication sent by the user containing the hyperlink 308. The hyperlink directs the recipient of the e-mail, text message, or instant message to the administrative entity's website where the recipient may register and repeat the process for himself or herself

Users benefit by being able to participate in directing money toward their chosen charitable causes. Speed and efficiency of technology, in particular email and computers, allows users to send and receive email just as fast as normal, even with the added hyperlink. As mentioned, the hyperlink could redirect the user to a website, side bar, or similar online location. In a version of the invention, the website or sidebar would permit the user to sort, review, and discuss the charitable causes, which could also increase awareness of the charitable cause and its goals.

In a version of the invention, after the contribution is made to the charitable cause, the user receives a message, such as an email message, identifying the sponsoring entity or entities that contributed the initial funds allocated by the user to the charitable cause. This message might also include one or more hyperlinks to internet website(s) of the sponsoring entity or entities, coupons, or other advertising information to gain the user as a potential consumer of the donating sponsoring entity.

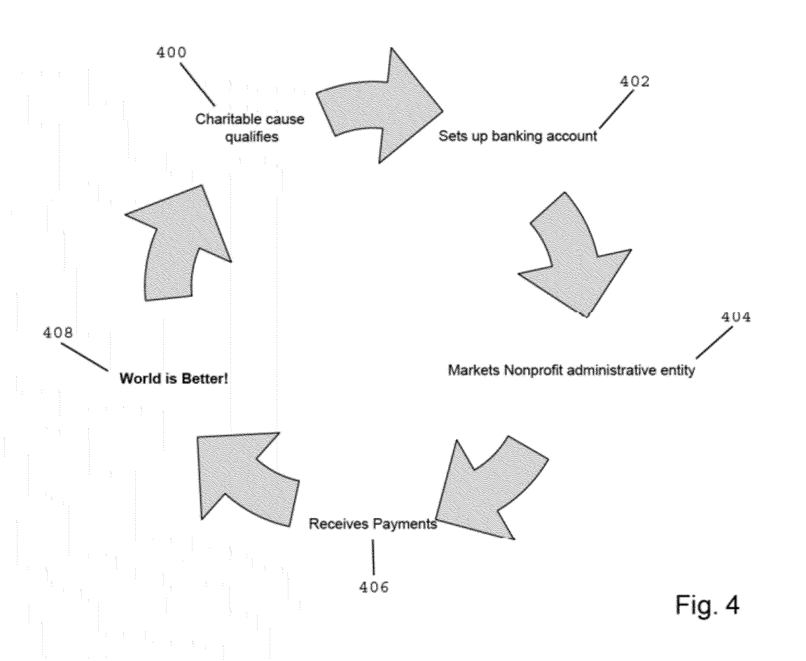

FIG. 4 shows the process from the perspective of the charitable organization or cause. Once the charitable organization qualifies 400, the nonprofit administrative entity sets up an account for the charitable organization 402. The charitable organization then helps to market the nonprofit administrative entity 404 and, in exchange, receives payments to further the goals of the charitable cause 406. Payments are applied to the account and the world becomes a better place as everybody is helping each other 408.

The disclosed process benefits the charitable cause by increasing awareness and contributions. It also lessens the charitable cause's overall marketing budget, which for many charities makes up the lion's share of its expenses.

Features of this process include, that it is free to the user; it is noninvasive since it generally only requires email and mobile phone information; it periodically sends update messages from the nonprofit administrative entity indicating total credits; the user is notified by message when a requested charitable entity is qualified; and it allows users to personalize their donation efforts by selecting their own charitable causes.

In some embodiments, the sponsor may conduct a search on the administrative entity's website for users having a particular profile that matches the desires of the sponsor. The sponsor can then donate money to the charitable organization designated by the user according to the user's profile and send a targeted advertisement to that user. When the user receives the advertisement from the sponsor, the user can take pleasure in knowing that a donation has just been sent to a charitable cause of the user's choosing. This benefits the sponsor by allowing the sponsor to target users with higher likelihood of purchasing the sponsor's products or services. The user also benefit by knowing that his actions led to donations to a charitable organization of his or her choice.

The user can register with the administrative entity's website. During or after registration, the user can create a profile describing various characteristics of the user, such as demographic information, interests, hobbies, and the like. The more information in the user's profile, the higher the likelihood that the user will be identified by or matched with a sponsor.

The user's profile can be populated in a number of different ways to increase the likelihood that a sponsor will find the user and donate to the user's cause. For example, the user can improve the likelihood that a sponsor will donate to the user's charitable organization if the user visits the sponsor's website. In some embodiments, the user may conduct a search on the administrative agencies website for a particular sponsor, good, or service. If the user links to the sponsor's website from the administrative entity's website a match is created, and the sponsor can be notified or such information can be kept track of in the user's profile. The sponsor will then be able to keep track of user's who are more likely to purchase from the sponsor. In some embodiments, the administrative entity may monitor the user's web browsing activity even if the user does not browse the web through the administrative entity's website.

The user can also populate its profile through the use of his or her own e-mail or other electronic communications. For example, the content of an e-mail may contain words that sponsors are particularly interested in. When e-mail is sent by user, the administrative entity may scan for certain keywords or correlatives established by a sponsor. These words can be added to the user's profile so a sponsor can conduct a search of keywords used in electronic communications sent by the user. To allow the administrative entity to scan the sent electronic communication, the electronic communication may be routed through the administrative entity's website or the administrative entity may create an add-in or plug-in software to run in the background of the user's electronic communicating device to monitor the electronic communications sent by the user.

The user can also populate its profile through the use of any other social networking websites or any other electronic communications, such as Twitter, Facebook, YouTube, and the like. From the user's home page on the administrative entity's website, the user can add these social networking accounts or e-mail accounts to the user's profile to allow the administrative entity to scan these electronic communications for correlatives established by the sponsors.

The user's webpage can also have a list of friends, contacts, sponsors, causes, and the like to add to its profile.

On the administrative entity's website, the user can either create a cause by recommending a charitable organization to be added to the list. In addition, the user can search for a cause to add to its list of charitable organizations in its profile.

Once the user has registered, the user can be taken to his or her homepage, which allows him or her to keep track of the various causes that have received donations due to the user's activities.

The sponsor can also register with the administrative entity's website and indicate in its profile, the characteristics of a user that the sponsor is interested in advertising to.

The charitable organization can also register with the administrative entity's website and begin populating its profile. The charitable organization will have to prove that it is a legitimate charitable organization.

The invention is implemented on electronic devices specifically programmed to carry out the methods described herein, such as computers, smart phones, tablets, and any other electronic device capable of transmitting information through the Internet, the airwaves, land lines, and the like. In some embodiments, after the registration process, the users, sponsors, and charitable organizations can use the administrative entity's website to conduct its electronic communications to effectuate the methods described herein. In some embodiments, the invention may be implemented into an existing electronic communications device or software as an add-in, plug-in, application, and the like to execute the steps described herein.

The system can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an apparatus or device that utilizes or implements electronic, magnetic, optical, electromagnetic, infrared signal or other propagation medium, or semiconductor system. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks comprise compact disk-read only memory (CD-ROM), compact disk-read/write (CD-R/W) and DVD.

A data processing system suitable for storing and/or executing program code comprises at least one processor coupled directly or indirectly to memory elements through a system bus. The memory elements can include local memory employed during actual execution of the program code, bulk storage, and cache memories that provide temporary storage of at least some program code in order to reduce the number of times code is retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

While the present invention has been described with regards to particular embodiments, it is recognized that additional variations of the present invention may be devised without departing from the inventive concept. For example the interface with the user or the recipient (or both) could be accomplished through an application (i.e. an app) on a mobile device. Furthermore, in versions of the invention, the sponsoring entity can be thought of as a donator, while the user can be thought of as an allocator. Also, the sponsoring entity can be thought of as a supplier, while the user can be thought of as a customer.

### INDUSTRIAL APPLICABILITY

This invention may be industrially applied to the development and use of methods and systems to encourage, obtain, and distribute charitable contributions.

What is claimed is:

1. A method of distributing charitable contributions through the use of electronic communications, comprising:
(a) receiving registration information from a plurality of sponsors;
(b) receiving registration information from a plurality of charitable organizations;
(c) receiving registration information from a plurality of users;
(d) establishing a user profile for each user and maintaining the user profile in an electronic database;
(e) receiving a list of user designated charitable organizations from the plurality of users;
(f) establishing a sponsor profile and maintaining the sponsor profile in the electronic database;
(g) receiving a plurality of donations from the plurality of sponsors;
(h) matching at least one user from the plurality of users with at least one sponsor from the plurality of sponsors;
(i) receiving a request to allocate a donation of the at least one matched sponsor to a selected charitable organization designated by the at least one matched user from the list of user designated charitable organizations; and
(j) depositing money into the selected charitable organization's account.

2. The method of claim 1, further comprising electronically sending information contained in the user's profile of the at least one matched user to the at least one matched sponsoring entity.

3. The method of claim 2, further comprising electronically sending an advertisement of the at least one matched sponsor to the at least one matched user whose designated charitable organization received an allocation of the donation.

4. The method of claim 1, wherein the matching step comprises:
(a) receiving an electronic search query from the at least one sponsor about the plurality of users; and
(b) electronically communicating a list of any of the users whose user profile matches the search query of the at least one sponsor.

5. The method of claim 1, wherein the matching step comprises:
(a) scanning an electronic communication sent by the at least one user to a recipient;
(b) identifying a word in the electronic communication that matches a correlative of the at least one sponsor; and
(c) notifying the at least one sponsor of the at least one user with whom a match was established.

6. The method of claim 5, further comprising:
(a) receiving an indication that the recipient has actuated a hyperlink contained in the electronic communication sent by the at least one user; and
(b) crediting the at least one user with a point for the actuation of the hyperlink by the recipient.

7. The method of claim 5, further comprising:
(a) crediting the at least one user with a point for the sending the electronic communication containing the correlative of the at least one sponsor; and
(b) redeeming a user's credits for money.

8. A system of distributing charitable contributions, comprising a server connected to a network, the server receiving registration information from users via the network, the server comprising at least one processor; a database for storing registration information; and a memory operatively coupled to the processor, the memory storing program instructions that when executed by the processor, causes the processor to:
(a) receive registration information from a plurality of sponsors;
(b) receive registration information from a plurality of charitable organizations;
(c) receive registration information from a plurality of users;
(d) establish a user profile for each user and maintaining the user profile in an electronic database;
(e) receive a list of user designated charitable organizations from the plurality of users;
(f) establish a sponsor profile and maintaining the sponsor profile in the electronic database;
(g) receive a plurality of donations from the plurality of sponsors;
(h) match at least one user from the plurality of users with at least one sponsor from the plurality of sponsors;
(i) receive a request to allocate a donation of the at least one matched sponsor to a selected charitable organization designated by the at least one matched user from the list of user designated charitable organizations; and
(j) deposit money into the selected charitable organization's account.

9. The method of claim 8, further comprising electronically sending information contained in the user's profile of the at least one matched user to the at least one matched sponsoring entity.

10. The method of claim 9, further comprising electronically sending an advertisement of the at least one matched sponsor to the at least one matched user whose designated charitable organization received an allocation of the donation.

11. The method of claim 8, wherein the matching step comprises:
(a) receiving an electronic search query from the at least one sponsor about the plurality of users; and
(b) electronically communicating a list of any of the users whose user profile matches the search query of the at least one sponsor.

12. The method of claim 8, wherein the matching step comprises:
(a) scanning an electronic communication sent by the at least one user to a recipient;
(b) identifying a word in the electronic communication that matches a correlative of the at least one sponsor; and
(c) notifying the at least one sponsor of the at least one user with whom a match was established.

13. The method of claim 12, further comprising:
(a) receiving an indication that the recipient has actuated a hyperlink contained in the electronic communication sent by the at least one user; and
(b) crediting the at least one user with a point for the actuation of the hyperlink by the recipient.

14. The method of claim 12, further comprising:
(a) crediting the at least one user with a point for the sending the electronic communication containing the correlative of the at least one sponsor; and
(b) redeeming a user's credits for money.

15. A computer readable medium storing instructions for causing at least one processor to perform a method that allows a user to allocate money donated by a sponsor to a charitable organization of the user's choice, the method comprising:
(a) receiving registration information from a plurality of sponsors;
(b) receiving registration information from a plurality of charitable organizations;
(c) receiving registration information from a plurality of users;
(d) establishing a user profile for each user and maintaining the user profile in an electronic database;
(e) receiving a list of user designated charitable organizations from the plurality of users;
(f) establishing a sponsor profile and maintaining the sponsor profile in the electronic database;
(g) receiving a plurality of donations from the plurality of sponsors;
(h) matching at least one user from the plurality of users with at least one sponsor from the plurality of sponsors;
(i) receiving a request to allocate a donation of the at least one matched sponsor to a selected charitable organization designated by the at least one matched user from the list of user designated charitable organizations; and
(j) depositing money into the selected charitable organization's account.

16. The method of claim 15, further comprising electronically sending information contained in the user's profile of the at least one matched user to the at least one matched sponsoring entity.

17. The method of claim 16, further comprising electronically sending an advertisement of the at least one matched sponsor to the at least one matched user whose designated charitable organization received an allocation of the donation.

18. The method of claim 15, wherein the matching step comprises:
(a) receiving an electronic search query from the at least one sponsor about the plurality of users; and
(b) electronically communicating a list of any of the users whose user profile matches the search query of the at least one sponsor.

19. The method of claim 15, wherein the matching step comprises:
(a) scanning an electronic communication sent by the at least one user to a recipient;
(b) identifying a word in the electronic communication that matches a correlative of the at least one sponsor; and
(c) notifying the at least one sponsor of the at least one user with whom a match was established.

20. The method of claim 19, further comprising:
(a) crediting the at least one user with a point for the sending the electronic communication containing the correlative of the at least one sponsor; and
(b) redeeming a user's credits for money.
